(19) United States
(12) Patent Application Publication
(10) Pub. No.: US 2026/0124588 A1
(43) Pub. Date: May 7, 2026

(54) COMPOUNDING SYSTEM

(71) Applicant: THE COMPOUNDING COMPANY B.V., Heemstede (NL)

(72) Inventor: Sebastiaan LOON VAN, Heemstede (NL)

(73) Assignee: THE COMPOUNDING COMPANY B.V., Heemstede (NL)

(21) Appl. No.: 19/114,351

(22) PCT Filed: Nov. 13, 2023
(86) PCT No.: PCT/NL2023/050598

§ 371 Date: Mar. 21, 2025

(30) Foreign Application Priority Data
Nov. 14, 2022 (NL) 2033522

(51) Int. Cl. B01F 35/42; A61J 3/00; B01F 33/84; B01F 35/21; B01F 101/22

(52) U.S. Cl. CPC B01F 35/42; A61J 3/002; B01F 33/84; B01F 35/2117; A61J 2200/74; B01F 2101/22

(57) ABSTRACT

According to the invention, a compounding system for dosing a compound comprising stations (200) for receiving repositories (300) arranged for holding compounds, wherein each repository comprises: a holder (310) for holding a compound; and a holder coupling end (302) providing fluid access to the holder; wherein at least one station comprises a weighing unit (210) comprising a cradle (211) arranged for receiving the repository and arranged for weighing the cradled repository; wherein the compounding system comprises unloading means (220) arranged for unloading the weighing unit providing a loaded condition and an unloaded condition; wherein in the loaded condition the holder coupling end is decoupled, and the received repository is arranged to the cradle for weighing; and wherein the unloading means are in the unloaded condition when the holder coupling end of the received repository in the at least one station is being coupled to or decoupled from a container such that the received repository is prohibited from overloading the weighing unit.

### FIELD OF THE INVENTION

The invention relates to a compounding system. The invention more specifically relates to dosing a compound in a repository held by the compounding system. The invention further relates to an adapter for holding the repository in the compounding system.

### BACKGROUND OF THE INVENTION

Pharmacies, especially hospital pharmacies, have to compound medicines. These medicines may be compounded in the form of pills, but also in the form of syringes or infusion bags filled with a compounded substance. This compounding may be automated by coupling a syringe or infusion bag to a compounding system.

For example, US2017008651A1 discloses a machine and a method for the automatic preparation of substances for intravenous application. The machine works by puncturing a container with the needle of a syringe for thereafter drawing a liquid from the container in the syringe. US2017008651A1 further discloses in FIG. 8 a machine for dosing a compound in the container. Disadvantages of US2017008651A1 are that the machine is bulky, and mechanically complex resulting in an error prone machine. Furthermore, dosing with the disclosed machine is inaccurate and/or unvalidated.

WO 20217224787 A1 discloses an apparatus for drug preparation, comprising: a first rotor adapted to support a first container for the drug and available, in a releasable manner, on the first rotor; a second rotor adapted to support a plurality of second containers, each containing a respective ingredient, pumping means, controllable by a control unit so as to transfer each ingredient from the respective second container into the first container; a weighing device, adapted to weigh the first container and comprising a translation means, a loading cell and at least one spacer adapted to support the first container. In a condition where the spacer supports the first container by decoupling it from the first support element, the loading cell is adapted to continuously generate, during the transfer of the ingredient, a quantity indicative of a weight force. A disadvantage of the is that the weighing device is inaccurate and regularly breaks down.

### SUMMARY OF THE INVENTION

An object of the invention is to overcome one or more of the disadvantages mentioned above. According to a first aspect of the invention, a compounding system for dosing a compound comprising stations for receiving repositories arranged for holding compounds, wherein each repository comprises: a holder for holding a compound; and a holder coupling end providing fluid access to the holder; wherein at least one station comprises a weighing unit comprising a cradle arranged for receiving the repository and arranged for weighing the cradled repository; wherein the compounding system comprises unloading means arranged for unloading the weighing unit providing a loaded condition and an unloaded condition; wherein in the loaded condition the received repository is arranged to the cradle for weighing; a container holder (120) for holding a container (10); and coupling means for coupling and decoupling the container held in the container holder to and from the received repository; wherein the unloading means are in the unloaded condition when the holder coupling end of the received repository in the at least one station is being coupled to or decoupled from the container such that the received repository is prohibited from overloading the weighing unit; and wherein the unloading means are configured for arranging the cradle of the at least one station in the unloaded condition while the holder coupling end of the received repository in the at least one station is coupled to the container for exchanging fluid.

A compounding system is a system arranged for compounding substances or compounds, such as liquids or gels. The compounded substance is typically collected in a container and/or repository. Alternatively, the container and/or repository collects the different substances making up the compounded substance. The container is typically used for transporting and/or temporarily storing the compounded substance. The repository may provide a supply of compound or substance and/or may hold the finally compounded compound or substance. The compounded substance in the container and/or repository may be administered to a patient.

The compounding system is typically used in medical settings, such as in a hospital pharmacy, for compounding syringes and/or infusion bags. The compounding system advantageously may alleviate manual labour. Furthermore, the compounding system may replace manual operation preventing dosing failures. Both these advantages may also apply to the automated dosing of the container and/or repository.

The container is typically a syringe. Syringes are typically standardized in the medical sector. The container has a container body typically provided with an inner space or a volume for holding or containing the compounded substance. The container also has a plunger typically arranged inside the container body for controlling, regulating and/or changing the container volume. The container body may have an elongated shape defining an elongated axis. The plunger may also have an elongated shape. The plunger may further be shaped to travel inside the container body along the elongated axis for controlling, regulating and/or changing the container volume.

The repository is typically a syringe or infusion bag. The repository may provide a supply of compound or substance. The repository may hold the compounded compound or substance. In the latter case, the repository is typically decoupled from the compounding system for thereafter administering the substance or compound to a patient. The repository comprises a holder for holding the compound. The holder of the repository may be the container body of a syringe or an infusion bag. The repository, more specific the holder, preferably comprises a holder coupling which may be a Luer coupling.

The compounding system comprises at least one station, typically a plurality of stations. At least one station comprises weighing unit comprising a cradle arranged for receiving the repository and for weighing the cradled repository. Preferably, all stations comprise a weighing unit.

The compounding system may hold one or more repositories. These one or more repositories depending on its function may be substance or compound drawn from, or substance or compound provided to. The amount of compound or substance is typically critical in medical applications, specifically in chemotherapy. One way of validating the amount of compound or substance in a repository is the accurate control of the containers drawing or providing substance from or to the repository. This validation is typically based on knowledge of the container type and controlling of this container, such as a syringe and a plunger of the syringe and is seen as a first validation.

The weighing unit for the at least one station provides a way of weighing the content of the repository. Based on the weight of the cradled repository, the amount of substance or compound, such as the volume of the substance or compound is calculable. This compounding system provides an additional and independent validation of the amount of substance or compound in the repository. The second validation provides the ability to prevent errors in the amount of compounded substance that were not prevented with the first validation. The second validation provides additional safety to the patient when administering the compounded substance. Thus, this compounding system increases the chance that the correct amount is administered. This compounding system may be defined as compounding system for dosing a compound comprising stations for receiving repositories arranged for holding compounds, wherein each repository comprises: a holder for holding a compound; and a holder coupling end providing fluid access to the holder; wherein at least one station comprises a weighing unit comprising a cradle arranged for receiving the repository and arranged for weighing the cradled repository.

A prerequisite of the second validation is that the weighing unit is accurate and has a high dependability of operation. It is an insight of the inventor that weighing units having a high accuracy are less resistant against overloading causing a significant reduction in mean time between failure. It is a further insight of the inventor that during coupling and decoupling of the repository and the container the load on the weighing unit may spike causing an overload situation, typically a high overload situation. These spikes may cause a degradation of the accuracy of the weighing unit. After one or more of these spikes the weighing unit may need recalibration. Further, these spikes may cause the weighing unit to break down early resulting in a decrease of the mean time between failure. The unloading means provide a loaded and an unloaded condition. In the loaded condition the holder coupling end is preferably decoupled, and the received repository is arranged to the cradle for weighing. Thus, the second validation is securely done during that spikes in the load do not occur. Further, when the unloading means are in the unloaded condition, the holder coupling end of the received repository in the at least one station is being coupled to or decoupled from a container for exchanging fluid such that the received repository is prohibited from overloading and/or prevented to overload the weighing unit. The unloaded condition prohibits and/or prevents load spikes of the coupling or decoupling to overload the weighing unit. Preventing overloading the weighing unit has the technical effect of at least preventing inaccuracies due to the need of early recalibration of the weighing unit. Further, preventing overloading the weighing unit has the technical effect of prolonging the lifetime of the weighing unit thereby increasing the mean time between failure.

According to another aspect of the invention, an adapter shaped to adapt the shape of the repository to cooperate with the at least one station according to any of the embodiments of the claimed compounding system. The adapter provides the same advantages as mentioned for the compounding system. The adapter further provides the option to snugly and/or seamlessly fit into the at least one station, preferably all stations, of the compounding system.

According to another aspect of the invention, a repository arranged for cooperating, preferably together with an adapter, with a compounding system according to any of the embodiments of the claimed compounding system. The repository provides the same advantages as mentioned for the compounding system.

### DETAILED DESCRIPTION OF EXEMPLARY EMBODIMENTS

In an embodiment of the compounding system, the unloading means are configured for arranging the cradle of the at least one station in the unloaded condition while the received repository is coupled to and decoupled from the container. The container in a coupled condition is typically arranged for exchanging fluid. Overloading of the received repository may occur during coupling and decoupling. This embodiment advantageously prohibits overloading during both, coupling and decoupling.

In an embodiment of the compounding system, the coupling means comprise a rotation actuator and/or a translation actuator. The rotation actuator and/or the translation actuator, preferably the combination, may advantageously be arranged for coupling and decoupling the container held in the container holder to and from the received repository.

In an embodiment of the compounding system, the rotation actuator comprises a rotation motor, and a gear wheel driving the container holder. This is a preferred embodiment for implementing the rotation or rotational actuator.

In an embodiment of the compounding system, the translation actuator comprises a translation motor, a translation spindle, a translation spindle nut, and a translation slider. This is a preferred embodiment for implementing the translation actuator.

In an embodiment of the compounding system, the received repository in the at least one station is in the unloaded condition while the holder coupling end of the received repository in the at least one station is coupled to the container for exchanging fluid. The container has a particular weight. The weight of the container together with the weight of the received repository may be a weight potentially overloading the weighing unit. Furthermore, the position of the container is typically determined by container positioning means. When the position of the container is changed or e.g. slipping due to the positioning means being unpowered, and when the container is also coupled to the received repository, the weighing unit may potentially overloaded. The overload of the weighing unit is advantageously prevented while the container is coupled to the received repository by arranging the received repository in the unloaded condition.

In an embodiment of the compounding system, the unloading means in the loaded condition provide a received and a cradled position to the container; and the unloading means in the unloaded condition provide a received and an uncradled position to the container. The unloading means are advantageously arranged to change the position of the received repository between a cradled position and an uncradled position. In a particular embodiment, the change from uncradled position to cradled position is accomplished by not powering the unloading means and allowing gravity to change the position of the received repository for advantageously mechanically simplifying the unloading means. In another embodiment, the unloading means comprise a support for supporting the weighing unit such that overloading of the weighing unit is prevented. In particular, the weighing unit may comprise a load cell, an arm extending from the load cell, and a cradle at a distal end of the arm. The support may advantageously support the arm prohibiting overloading of the load cell.

In an embodiment of the compounding system, the unloading means comprise a spring for biasing the repository in the unloaded condition. The spring is typically arranged to the container such that the spring may be advantageously reused when the container is coupled to and/or decoupled from different stations.

In a further embodiment of the compounding system, the compounding system comprises: a container holder for holding the container; and a frame supporting the container holder and the at least one station; wherein the spring is arranged to the container holder for biasing the received repository in the unloaded position. The spring is typically arranged to the container. The spring arranged as claimed biases the container, when coupling to and/or decoupling from the received repository, preferably pushes the received repository, in the unloaded condition, preferably the uncradled position.

In an embodiment of the compounding system, the spring is arranged for biasing the received repository upwards. Biasing upwards advantageously allows for one condition change, typically from the unloaded condition, preferably the uncradled position, to the loaded condition, preferably the cradled position, to be affected by gravity by taking away or limiting the bias of the spring.

In an embodiment of the compounding system, the unloading means are arranged such that the unloaded condition, preferably the uncradled position, is vertically above the loaded condition, preferably the cradled position.

Arranging the conditions, preferably the positions, vertically above each other advantageously allows for one condition change, typically from the unloaded condition, preferably the uncradled position, to the loaded condition, preferably the cradled position, to be affected by gravity.

In an embodiment of the compounding system, the holder coupling end comprises a first thread; wherein the container comprises a container coupling end comprising a second thread; wherein the holder coupling end and the container coupling end are shaped for forming a threaded coupling; wherein the compounding system comprises: a rotation actuator for rotating the container for coupling to and decoupling from repository; and a controller configured for controlling the unloading means and rotation actuator such that the unloading means are in the unloaded condition during that the repository is coupled to and/or decoupled from the container. The rotational actuator typically rotates the container holder for rotating the container held in the container holder. The holder coupling end may comprise a Luer coupling end, and the container coupling end may comprise a Luer coupling end cooperating with the Luer coupling end of the holder coupling end for forming a Luer coupling when the received repository and the container are coupled. The first and the second thread may advantageously provide a fluid-leak free coupling. The first and the second thread advantageously provide that a bias, such as from the unloading means preferably the spring for biasing of the container, is usable to transfer the bias from the container to the received repository before coupling or decoupling for providing the unloaded position to the received repository.

In an embodiment of the compounding system, an adapter is arranged to the repository for adapting the shape of the repository to cooperate with the at least one station. The adapter advantageously allows to simplify the shape of the at least one station. The adapter advantageously allows to use standardized repositories, more specific standardized holder, such as standard infusion bags and/or syringes.

In a further embodiment of the compounding system, the at least one station has a shape preventing rotation of the received repository in the at least one station. Rotation may be part of coupling and/or decoupling. Arranging the received repository such that the received repository cannot rotate, the coupling and/or the decoupling can advantageously be affected by at least rotating the container relative to the received repository.

In a further embodiment of the compounding system, the shape of the at least one station comprises a hole arranged for receiving the repository vertically from above. The hole as well as receiving vertically form above provides the advantage of using gravity for changing from unloaded condition to loaded condition or vice versa for advantageously simplifying the mechanics of the unloading means further preventing overloading the weighing unit.

In a further embodiment of the compounding system, the hole comprises a stability notch arranged for cooperating with a stability protrusion of the received repository or an/the adapter for the received repository for prohibiting rotation, preferably in a horizontal plane, and/or guiding translation of the received repository or the adapter for the received repository, preferably in a vertical direction. This is an advantageous stable embodiment of the compounding system further preventing overloading the weighing unit.

In an embodiment of the compounding system, the received repository or an/the adapter for the received repository comprises at least two, preferably three, weighing protrusion; and the cradle comprises at least two, preferably three, contacting surfaces arranged for supporting the at least two weighing protrusions in the loaded condition, preferably the cradled position. Three protrusions advantageously provide a stable configuration further preventing overloading the weighing unit.

In an embodiment of the compounding system, the at least one station comprises: receiving notches arranged for receiving the repository or an/the adapter for the received repository, preferably when depending on the preceding claim the at least two weighing protrusions; and locking means arranged for sliding out of the notches when the repository or the adapter for the repository is received, and confining the received repository or the adapter for the received repository to the loaded condition or the unloaded condition, preferably when depending on the preceding claim the at least two weighing protrusions, preferably to respectively the cradled position and the uncradled position. The notches are typically arranged for receiving the cooperating protrusions from above in a vertical direction. The notch and the locking means provide per protrusion a confined space for confining the protrusion to the confined space. The confined space typically provides a loaded and an unloaded condition, such as a cradled and uncradled position. The bottom of the confined space may advantageously be at least partly one of the contacting surfaces for supporting the protrusion in the loaded condition, preferably cradled position. The confined space provides the advantage that the protrusion and as a result the received repository and/or adapter cannot be taken out of the compounding system when the received repository is used for drawing fluid from or providing fluid to the received repository.

In a further embodiment of the compounding system, the locking means comprise sliding means, preferably rotational means, and an entrance surface; and the sliding means and the entrance surface are arranged for sliding the locking means out of the notches with the applied force of the repository or an/the adapter for the repository on the at least one station. This embodiment advantageously allows to place the repository and/or the adapter in the at least one station with only the use of the force of the repository and/or the adapter entering the at least one station.

In an embodiment of the compounding system, the at least one station comprises a manual control for manually controlling the sliding means for advantageously sliding the sliding means out of the notch for allowing the adapter and/or the repository to enter the confined space with minimum force or no force applied to the adapter and/or the repository. Preferably the adapter and/or the repository is lowered in the at least one station gradually to prevent an impact and subsequent overload on the weighing unit, preferably when in a vertical arrangement. In an advantageous embodiment the manual control is combined with an entrance surface for minimizing the force applied to the repository while receiving for advantageously preventing or reducing the chance to hit or strike, and subsequently overloading the weighing unit.

In an embodiment of the compounding system, the locking means comprise an abutment surface arranged for abutting the received repository in the unloaded condition, preferably to the uncradled position. In a preferred embodiment, the sliding means form the top of the confined space wherein the protrusion is confined. The abutment may be the underside of the sliding means, thereby forming the ceiling of the confined space. The abutment is advantageously abutting the received repository, preferably the protrusion of the repository and/or the adapter, while the repository is arranged in the unloaded condition, preferably uncradled position, while being biased in that condition.

In an embodiment of the compounding system, the weighing unit comprises a load cell connected eccentric to the cradle. Typically, the weighing unit comprises an arm, and a load cell arranged to an end of the arm, and a cradle arranged at another end of the arm. The weighing unit advantageously allows to weigh the received repository with one load cell while also receiving the repository centred to the station, more specifically the hole of the station, simplifying the mechanical structure of the at least one station.

### BRIEF DESCRIPTION OF THE DRAWINGS

The invention will be apparent from and elucidated further with reference to the embodiments described by way of example in the following description and with reference to the accompanying drawings, in which:

FIG. 1 schematically shows a detail of a top view of a compounding system;

FIG. 2 schematically shows a detail of a top perspective view of a compounding system;

FIG. 3 schematically shows a perspective view of a repository comprising a holder and an adapter for a compounding system;

FIG. 4 schematically shows a perspective view of a repository without a holder and with an adapter for a compounding system;

FIG. 5 schematically shows a perspective view of an adapter for a compounding system;

FIG. 6 schematically shows a detail of a top perspective view of a compounding system;

FIG. 7 schematically shows a side view of a cross section of a detail of a compounding system; and

FIG. 8 schematically shows a perspective view of a detail of a compounding system.

The figures are purely diagrammatic and not drawn to scale. In the figures, elements which correspond to elements already described may have the same reference numerals.

LIST OF REFERENCE NUMERALS

| | |
|---|---|
| 10 | container |
| 11 | first Luer coupling part |
| 12 | first Luer coupling end |
| 13 | container body |
| 14 | flanges |
| 15 | plunger |
| 100 | compounding system |
| 101 | frame |
| 120 | container holder |
| 130 | rotation actuator |
| 131 | rotation motor |
| 132 | gear wheel driving container holder |
| 133 | rotation belt |
| 140 | translation actuator |
| 141 | translation motor |
| 142 | translation spindle |
| 143 | translation spindle nut |
| 144 | translation slider |
| 145 | translation belt |
| 150 | unloading means |
| 151 | spring |
| 160 | position sensor |
| 161 | detector |
| 162 | detection strip |
| 170 | container fill means |
| 171 | plunger motor |
| 172 | plunger spindle |
| 173 | plunger holder |
| 174 | plunger slider |
| 175 | plunger belt |
| 199 | top plate |
| 200 | Luer coupling holder or station |
| 201 | hole |
| 202 | manual control |
| 210 | weighing unit |
| 211 | cradle |
| 212 | contacting surface |
| 213 | receiving notch |
| 214 | arm |
| 215 | sliding means |
| 216 | entrance surface |
| 217 | abutment surface |
| 300 | repository |
| 301 | second Luer coupling part |
| 302 | holder coupling end/second Luer coupling end |
| 310 | holder/compound supply |
| 311 | backplate |
| 312 | hook |
| 350 | adapter |
| 351 | stability protrusion |
| 352 | weighing protrusion |
| 353 | centre hole |
| 354 | adapter body |
| Af | first coupling axis |
| As | second coupling axis |
| Rrc | rotation container motor |
| Rtc | translation container motor |
| Rtp | translation plunger motor |
| Tc | translation container |
| Tp | translation plunger |
| H | horizontal direction |
| V | vertical direction |

### DETAILED DESCRIPTION OF THE FIGURES

The following figures may detail different embodiments. Embodiments can be combined to reach an enhanced or improved technical effect. These combined embodiments may be mentioned explicitly throughout the text, may be hinted upon in the text or may be implicit.

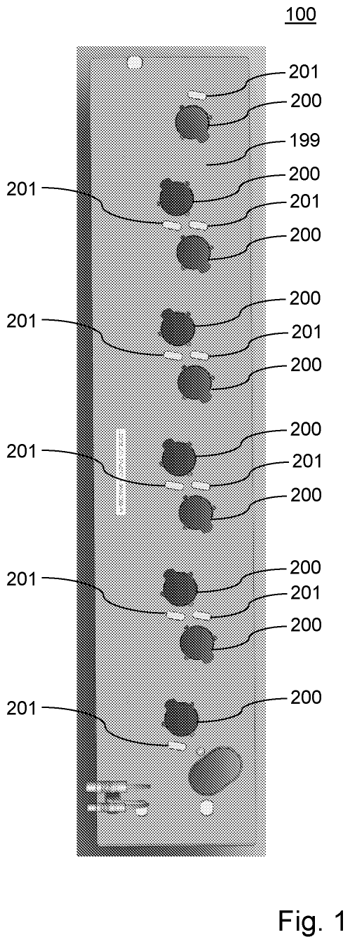

FIG. 1 schematically shows a detail of a top view of a compounding system 100. The compounding system comprises a top plate 199 comprising several stations 200. Each station may comprise a hole 201 shaped and/or arranged for receiving a repository. Further, each station may comprise a manual control 202, such as a knob, for manually controlling the sliding means—not shown—for controlling receiving a repository in and/or removing a repository from the station.

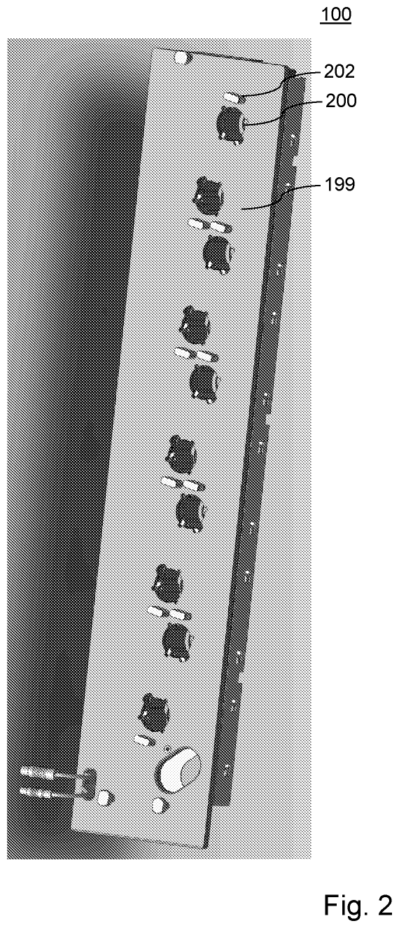

FIG. 2 schematically shows a detail of a top perspective view of a compounding system. FIG. 2 mainly shows the top plate also shown in FIG. 1 in perspective view. Furthermore, FIG. 2 shows that the top plate has depth extending downwards from the top of the compounding system for amongst others providing a station with a hole, such as a tubular shaped hole, for stably receiving the repository and/or the adapter with repository in the station, more specific the hole.

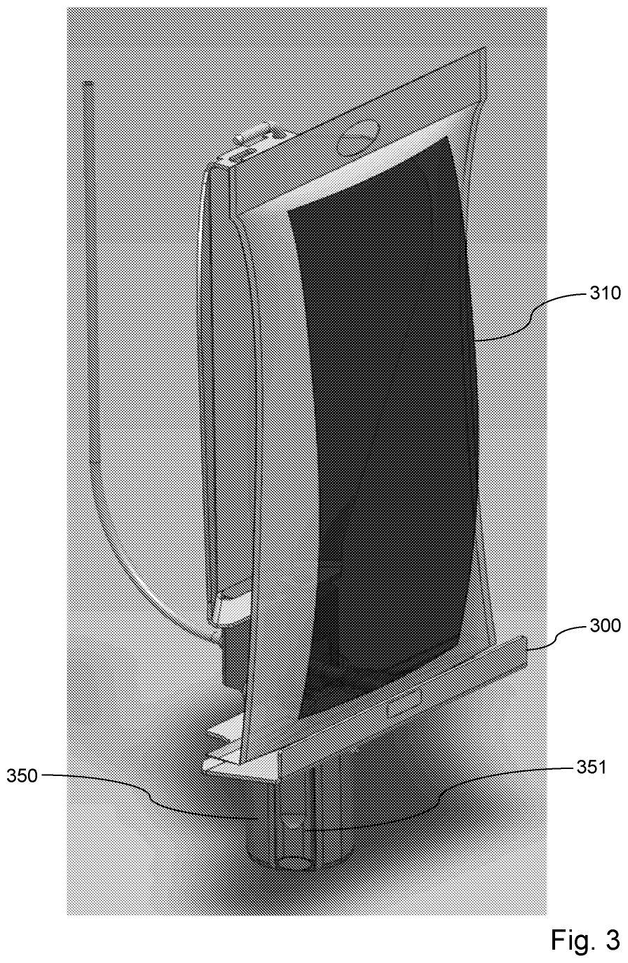

FIG. 3 schematically shows a perspective view of a repository 300 and an adapter 350 for a compounding system. The repository may comprise a holder 310. The holder may be an infusion bag. The repository typically allows easy exchange or replacement of the holder. The repository is typically received by the station with an adapter between the repository and the station. The adapter allows multiple repositories of different shapes and/or sizes to be received by the station.

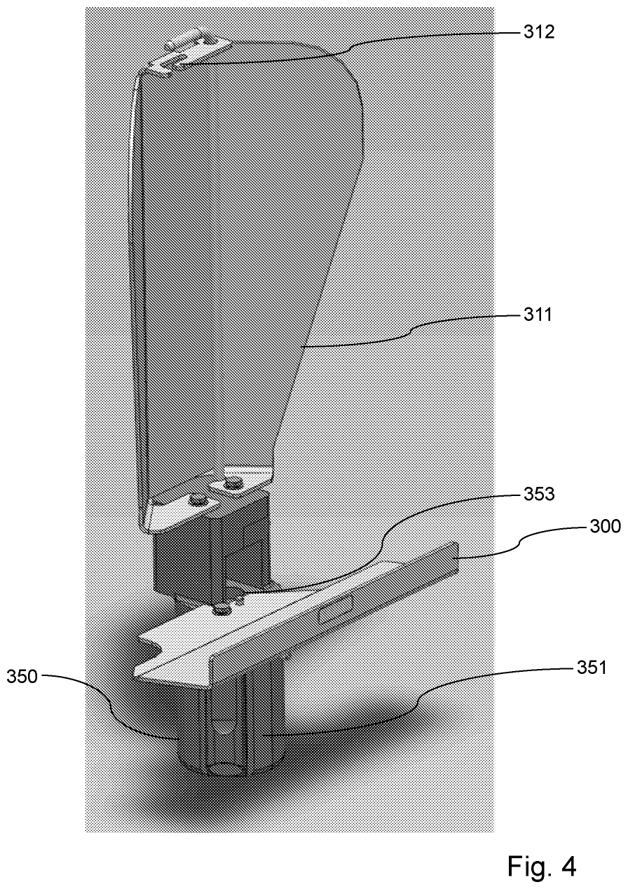

FIG. 4 schematically shows a perspective view of a repository without a holder, such as an infusion bag, and with an adapter for a compounding system. The repository and adapter in FIGS. 4 and 3 are the same. The repository may comprise a backplate 311 and a hook 312. The hook may be for suspending the holder from. The backplate may be for guiding the holder when placing the repository in the compounding system, and/or protecting the holder from puncturing the holder. Furthermore, the backplate may provide a stable platform for tilting the repository with holder such that the holder is well maintained or kept in position relative to the repository, for example when the repository is placed on a table resting on the backplate.

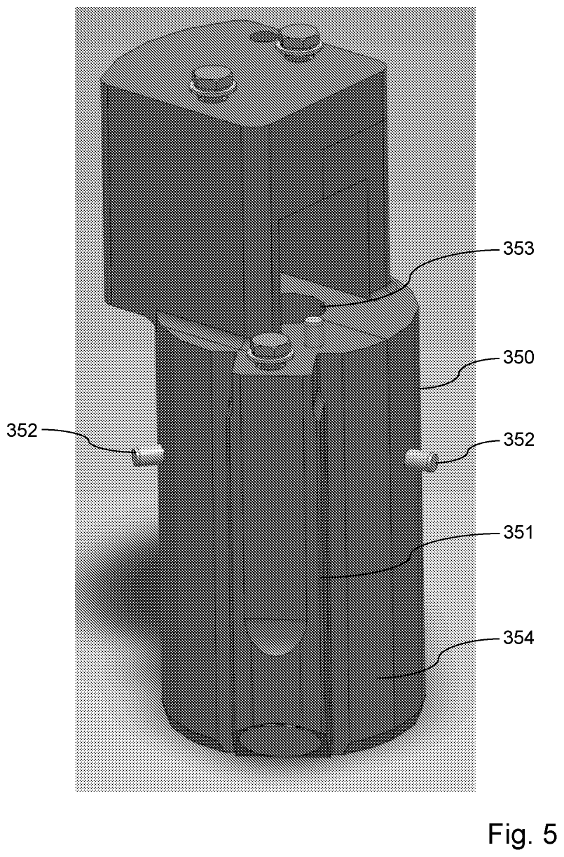

FIG. 5 schematically shows a perspective view of an adapter 350 for a compounding system 100. The adapter may comprise a stability protrusion 351, a weighing protrusion 352, a centre hole 353, and an adapter body 354.

The stability protrusion may have an elongated shape protruding radially from the adapters body. The elongated shape may be parallel to a centre line of the adapter body. The stability protrusion cooperating with the hole of the station wherein the adapter is received allows the adapter to translate in a vertical direction inside the station and prevents the adapter from rotating in a horizontal plane.

Two weighing protrusions are shown extending from the adapter body. The third weighing protrusion is at the back of the adapter body. The weighing protrusions when in the loaded condition, typically in a cradled position, are arranged to the cradled, such as resting on the cradle, for weighing.

The centre hole provides a through hole through the adapter body. The holder typically comprises a holder coupling end extending through the centre hole for allowing coupling at the other side, typically the bottom side, of the adapter. The holder coupling end is typically an integrated part of the holder preventing cross contamination between holders.

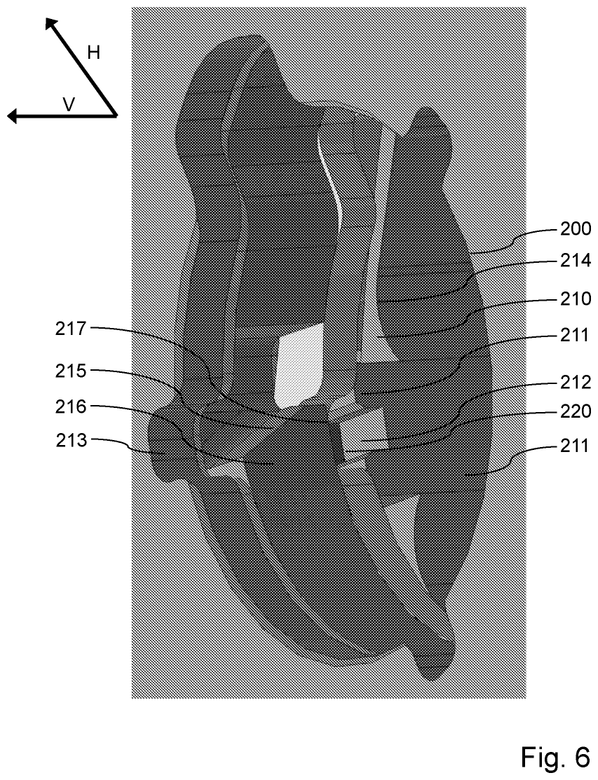

FIG. 6 schematically shows a detail of a top perspective view of a compounding system. More specific, FIG. 6 is a detail of the top plate 199. FIG. 6 shows a part of a station 200. Indications for the vertical direction V and the horizontal direction H are shown. The station comprises a weighing unit 210. The station may comprise receiving notches 213, and sliding means 215.

The weighing unit comprises a cradle 211. The weighing unit may comprise an arm 214 and a load cell—not shown—. The arm connects the cradle with the load cell, such that the weight resting on the cradle, which may be a repository, is weighable by the load cell. Typically, a single load cell is used. Typically, the arm allows the load cell to be arranged eccentric relative to the hole. The cradle may comprise a contacting surface 212 whereupon the weighing protrusion of the received adapter or the received repository may rest for weighing.

The sliding means may comprise an entrance surface 216, and an abutment surface 217. The entrance surface is shaped and arranged, such as positioned more specifically angled as shown, such that when a weighing protrusion entering the receiving notch will push the sliding means away and thus out of the receiving notch. The abutment surface is shaped and arranged, such as positioned more specifically angled as shown, such that together with the cradle and the sliding means a confined space is formed for confining a weighing protrusion. The abutment surface abuts the weighing protrusion in the confined space in the unloaded condition, such as in the uncradled position.

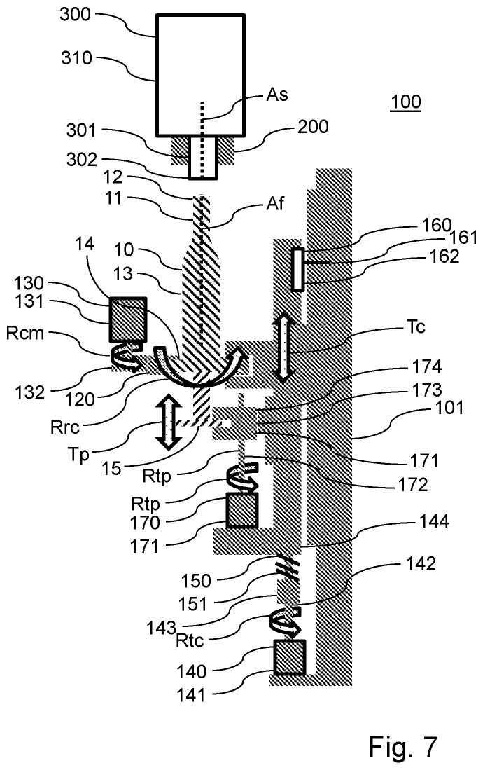

FIG. 7 schematically shows a side view of a cross section of a detail of a compounding system 100. The compounding system comprises a Luer coupling holder and/or a station 200, a container holder 120, a rotation actuator 130, a translation actuator 140, unloading means 150, and a controller. The compounding system may comprise a frame 101 arranged for providing a structure and/or mechanical reference to the compounding system and/or its features. The controller is not shown in FIG. 1. The compounding system is arranged for dosing a compound in a container 10. The container may comprise a container body 13. The container body typically encloses a volume for holding the doses compound. The container may comprise a first Luer coupling part 11 arranged to the container body, and a first Luer coupling end 12 which is a section of the first Luer coupling part and arranged at a distal end of the first Luer coupling part relative to the container body. The first Luer coupling part and/or the first Luer coupling end have a first coupling axis Af. The first coupling axis typically defines the elongated axis and/or the symmetry axis of the first Luer coupling part and/or the first Luer coupling end.

The Luer coupling holder or the station is arranged for holding a second Luer coupling end 21. The Luer coupling holder or the station may be arranged for receiving a repository 300. The repository may comprise a holder or compound supply 310. The holder and the compound supply may be a vial or e.g. a tube to a larger reservoir. Alternatively, the tube may lead to a fluid valve allowing multiple reservoirs or vials to supply a compound or part of the compound. The compound, substances making up the compound, or parts of the compound are typically a fluid, a gel and/or a suspension. The holder or the compound supply may comprise a second Luer coupling part 301 arranged for providing the compound, substances making up the compound, or parts of the compound, and a second Luer coupling end 302 providing an opening for fluidly coupling to the first Luer coupling end and/or the first Luer coupling part. The second Luer coupling part and/or the second Luer coupling end have a second coupling axis As. The second coupling axis typically defines the elongated axis and/or the symmetry axis of the second Luer coupling part and/or the second Luer coupling end.

The container holder is arranged for holding the container. The container may comprise flanges 14. The flanges typically extend from the container body. The flanges are typically used for gripping the container for manipulating, such as moving, the container. The container holder may be arranged for gripping the flanges for coupling the container holder and the container in a rotational and translational manner and/or direction. The Luer coupling holder and the container holder are arranged for aligning the first coupling axis and the second coupling axis.

The rotation actuator is arranged for rotating the container holder relative to the Luer coupling holder substantially around the first coupling axis. The rotation actuator may comprise a rotation motor 131, and a gear wheel 132 driving the container holder. The rotation motor may be coupled with one end with the frame and with a driving axis to the gear wheel for rotating Rrc the gear wheel relative to the frame. The gear wheel may drive the container holder for rotating Rrc the container holder relative to the frame. The Luer coupling holder may be fixated relative to the frame. The rotation motor induces a rotation of the container therefore induces a rotation Rrc of the first Luer coupling end relative to the second Luer coupling end. Rotation is moving one object relative to another object around a rotation axis.

The translation actuator is arranged for translating the container holder relative to the Luer coupling holder along the first coupling axis. The translation actuator may translate the container relative to the frame along the first coupling axis. The translation actuator may comprise a translation motor 141, a translation spindle 142, a translation spindle nut 143, and a translation slider 144. The translation motor is arranged for directly or indirectly turning, driving and/or rotating Rtc the translation spindle. The translation slider may translate along the frame in a translation direction Tc translating the container typically substantially equal to the first coupling axis. The translation slider is typically rotationally fixated to the frame. The slider may slide along the frame in a direction of the first coupling axis. The translation spindle nut is typically rotationally fixated to the slider. The translation motor may be fixated to the frame with one end and have an axis rotating Rtc relative to the frame. When the translation spindle rotates, the translation spindle nut travels along the translation spindle for inducing a translation Tc of the translation spindle nut and may induce a translation Tc of the translation slider. Translating is moving one object relative to another object along a straight line or substantially straight line.

The unloading means are arranged for biasing the first Luer coupling end and the second Luer coupling end when in contact in a direction of the first coupling axis, more specifically when in contact bias the received repository upwards. The unloading means may comprise a spring 151. The unloading means, such as the spring, may be arranged between the translation slider and the translation spindle nut. The unloading means typically provide a rotational fixation of the translation slider and the translation spindle nut. Typically, if the translation slider and the translation spindle nut translate over the same distance, the bias provided by the unloading means remains the same. Typically, if the translation slider and the translation spindle nut translate over an unequal distance, the bias provided by the unloading means changes. The unloading means typically provide a limited amount of translational freedom between the translation spindle nut and the translation slider.

After bringing the first Luer coupling end and the second Luer coupling end in contact, the translation slider may be translated or moved in a direction necessary for bringing the first Luer coupling end and the second Luer coupling end in contact and/or in a direction further pressing the first Luer coupling and the second Luer coupling end together. The effect of the unloading means is that this translation induces a bias biasing the contacting the first Luer coupling end and the second Luer coupling end together or towards each other. After biasing the first Luer coupling end and the second Luer coupling end, the rotation actuator may be activated for establishing the Luer coupling between the first Luer coupling end and the second Luer coupling end. Depending on the amount of bias, the translation actuator may be activated during this rotation loosely associated with the rate of rotation of the rotation actuator, or may even remain stationary or unpowered during rotation of the rotation actuator. This provides the advantage of simplifying or easing the control over the rotation actuator and the translation actuator.

The compounding system may comprise a position sensor 160. The position sensor is arranged for sensing a container holder position of the container holder relative to the Luer coupling holder along the first coupling axis and/or translation container direction Tc. The position sensor may comprise a detector 161, and a detector strip 162. The detector strip may be fixated on the translation slider. The detector may be fixated to the frame. The detector is typically arranged to the detector strip such that the position and/or the change of the position of the slider relative to the frame may be measured. Typically, the first Luer coupling end relative to the Luer container holder is known, predefined or can be deduced. Typically, the second Luer coupling end relative to the Luer coupling holder is known, predefined or can be deduced.

Alternatively, a method for deducing when the first Luer coupling end and the second Luer coupling end contact may comprise the steps of: translating the first Luer coupling end and the second Luer coupling end towards each other; detecting during translating when the position sensor does not sense a change in position; and if no change of position is sensed optionally stopping translating towards each other. When the position sensor does not sense a change in position, the first Luer coupling end and the second Luer coupling end contact each other. Furthermore, if during the translation towards each other at first instance a position change is sensed, the method may be stopped when the first Luer coupling end and the second Luer coupling end first make contact with each other. This advantageously allows to control the amount of bias and/or indentation provided by the unloading means. The method may also comprise the steps of before translating towards each other, translating the first Luer coupling end and the second Luer coupling end away from each other; detecting during translating away from each other when the position sensor does sense a change in position; and if a change of position is sensed stopping translating away from each other. When the position sensor does sense a change in position, the first Luer coupling end and the second Luer coupling end do not contact each other. With the additional steps, the first moment of contact may be determined even when the first Luer coupling end and the second Luer coupling end contact each other at the start of the method. The preceding additional method steps may also only be performed if when first translating the first Luer coupling end and the second Luer coupling end towards each other, it is detected that the first Luer coupling end and the second Luer coupling end are already in contact. The method may comprise the step of continuing translating the first Luer coupling end and the second Luer coupling end towards each other for a predefined distance and/or time. This step advantageously provides a specified or predetermined amount of bias and/or indentation.

The container such as a syringe may comprise a plunger 15. The plunger is typically arranged partly in the container body for controlling the volume held in the container body. The compounding system may comprise container fill means 170. The container fill means are arranged for controlling the filling and/or volume contained in the container, typically the container body. The container fill means may comprise a plunger motor 171, a plunger spindle 172, a plunger holder 173, and a plunger slider 174. The plunger slider may be rotationally fixated to the translation slider. The plunger slider may be translationally and/or movable along the translation slider. The plunger holder is shaped and arranged for holding the plunger and/or any other means controlling the volume of the container. The plunger slider and the plunger holder may form a single body and are typically fixated relative to each other. The plunger motor may be fixated at one end to the translation slider. The plunger motor may directly or indirectly rotate Rtp or drive a plunger spindle. The plunger slider may comprise an opening with a thread engaging the plunger spindle. When the plunger spindle is rotated, the plunger slider and thus the plunger is translated Tp along an axis equal or substantially equal to the first coupling axis.

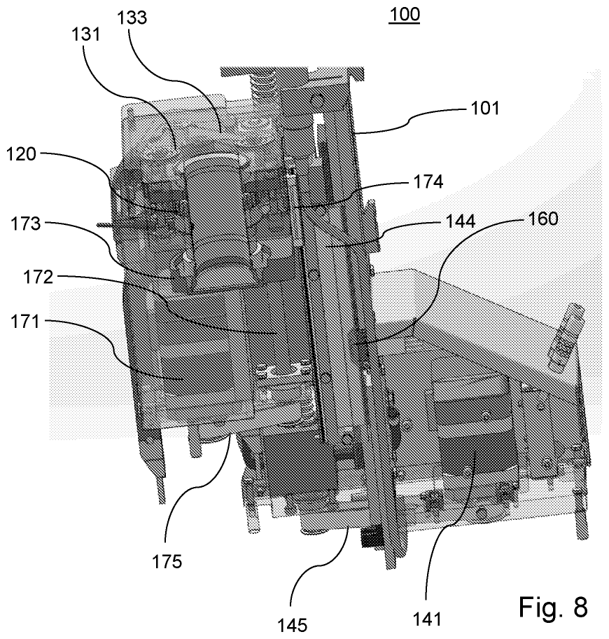

FIG. 8 schematically shows a perspective view of a detail of a compounding system 100. Parts of the compounding system are shown transparent. Parts of the compounding system are shown in a cross-sectional view. Parts of the compounding system are left out for clarity purposes only without impeding the disclosure of the invention. Shown is an embodiment wherein the translation actuator comprises a translation belt 145 for indirectly driving or rotating the translation spindle. Shown is an embodiment wherein the rotation actuator comprises a rotation belt 133 for indirectly driving or rotating the container holder. Shown is an embodiment wherein the container fill means comprise a plunger belt 175 for indirectly driving or rotating the plunger spindle.

It will also be clear that the above description and drawings are included to illustrate some embodiments of the invention, and not to limit the scope of protection. Starting from this disclosure, many more embodiments will be evident to a skilled person without departing from the scope of the invention as set forth in the appended claims. These embodiments are within the scope of protection and the essence of this invention and are obvious combinations of prior art techniques and the disclosure of this patent. Devices functionally forming separate devices may be integrated in a single physical device.

The term “substantially” herein, such as in “substantially all emission” or in “substantially consists”, will be understood by the person skilled in the art. The term “substantially” may also include embodiments with “entirely”, “completely”, “all”, etc. Hence, in embodiments the adjective substantially may also be removed. Where applicable, the term “substantially” may also relate to 90% or higher, such as 95% or higher, especially 99% or higher, even more especially 99.5% or higher, including 100%. The term “comprise” also includes embodiments wherein the term “comprises” means “consists of”. The term “functionally” will be understood by, and be clear to, a person skilled in the art. The term “substantially” as well as “functionally” may also include embodiments with “entirely”, “completely”, “all”, etc. Hence, in embodiments the adjective functionally may also be removed. When used, for instance in “functionally parallel”, a skilled person will understand that the adjective “functionally” includes the term substantially as explained above. Functionally in particular is to be understood to include a configuration of features that allows these features to function as if the adjective “functionally” was not present. The term “functionally” is intended to cover variations in the feature to which it refers, and which variations are such that in the functional use of the feature, possibly in combination with other features it relates to in the invention, that combination of features is able to operate or function. For instance, if an antenna is functionally coupled or functionally connected to a communication device, received electromagnetic signals that are receives by the antenna can be used by the communication device. The word “functionally” as for instance used in “functionally parallel” is used to cover exactly parallel, but also the embodiments that are covered by the word “substantially” explained above. For instance, “functionally parallel” relates to embodiments that in operation function as if the parts are for instance parallel. This covers embodiments for which it is clear to a skilled person that it operates within its intended field of use as if it were parallel.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. Thus, these terms are not necessarily intended to indicate temporal or other prioritization of such elements.

The devices or apparatus herein are amongst others described during operation. As will be clear to the person skilled in the art, the invention is not limited to methods of operation or devices in operation.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and “to include”, and its conjugations does not exclude the presence of elements or steps other than those stated in a claim. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The article “a” or “an” preceding an element does not exclude the presence of a plurality of such elements.

The invention may be implemented by means of hardware comprising several distinct elements, and by means of a suitably programmed computer. In the device or apparatus claims enumerating several means, several of these means may be embodied by one and the same item of hardware. The mere fact that certain measures are recited in mutually different dependent claims does not indicate that a combination of these measures cannot be used to advantage.

The invention further applies to an apparatus or device comprising one or more of the characterising features described in the description and/or shown in the attached drawings. The invention further pertains to a method or process comprising one or more of the characterising features described in the description and/or shown in the attached drawings.

It will be appreciated that the invention also applies to computer programs, particularly computer programs on or in a carrier, adapted to put the invention into practice. The program may be in the form of a source code, a code intermediate source and an object code such as in a partially compiled form, or in any other form suitable for use in the implementation of the method according to the invention. It will also be appreciated that such a program may have many different architectural designs. For example, a program code implementing the functionality of the method or system according to the invention may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise function calls to each other. An embodiment relating to a computer program product comprises computer-executable instructions corresponding to each processing stage of at least one of the methods set forth herein. These instructions may be sub-divided into sub-routines and/or stored in one or more files that may be linked statically or dynamically. Another embodiment relating to a computer program product comprises computer-executable instructions corresponding to each means of at least one of the systems and/or products set forth herein. These instructions may be sub-divided into sub-routines and/or stored in one or more files that may be linked statically or dynamically.

The carrier of a computer program may be any entity or device capable of carrying the program. For example, the carrier may include a data storage, such as a ROM, for example, a CD ROM or a semiconductor ROM, or a magnetic recording medium, for example, a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or used in the performance of, the relevant method.

The various aspects discussed in this patent can be combined in order to provide additional advantages. The mere fact that certain measures are recited in mutually different claims does not indicate that a combination of these measures cannot be used to advantage. Furthermore, some of the features can form the basis for one or more divisional applications.

1. A compounding system for dosing a compound comprising stations for receiving repositories arranged for holding compounds,
wherein each repository comprises:
a holder for holding a compound; and
a holder coupling end providing fluid access to the holder:
wherein at least one station comprises a weighing unit comprising a cradle arranged for receiving the repository and arranged for weighing the cradled repository;
wherein the compounding system comprises
unloading means arranged for unloading the weighing unit providing a loaded condition and an unloaded condition:
wherein when the unloading means are in the loaded condition, the received repository is arranged to the cradle for weighing; and
wherein when the unloading means are in the unloaded condition, the weighing unit is prohibited from weighing:
a container holder for holding a container; and
coupling means for coupling and decoupling the container held in the container holder to and from the received repository:
characterized in that:
the unloading means are in the unloaded condition while the holder coupling end of the received repository in the at least one station is coupled to the container for exchanging fluid; and
the unloading means are arranged such that the unloaded condition is vertically above the loaded condition.

2. The compounding system according to claim 1, wherein the unloading means are in the unloaded condition when the holder coupling end of the received repository in the at least one station is being coupled to or decoupled from the container such that the received repository is prohibited from overloading the weighing unit.

3. The compounding system according to claim 1, wherein the unloading means are configured for arranging the cradle of the at least one station in the unloaded condition while the received repository is coupled to and decoupled from the container.

4. The compounding system according to claim 1, wherein the coupling means comprise a rotation actuator and/or a translation actuator.

5. The compounding system according to claim 4, wherein the rotation actuator comprises a rotation motor, and a gear wheel driving the container holder.

6. The compounding system according to claim 3, wherein the translation actuator comprises a translation motor, a translation spindle, a translation spindle nut, and a translation slider.

7. The compounding system according to claim 1,
wherein the unloading means in the loaded condition provide a received and a cradled position to the received repository; and
wherein the unloading means in the unloaded condition provide a received and an uncradled position to the received repository.

8. The compounding system according to claim 7, wherein the unloading means are arranged such that the uncradled position is vertically above the cradled position.

9. The compounding system according to claim 1,
wherein the unloading means comprise a spring for biasing the repository in the unloaded condition;
wherein the compounding system comprises a comprising a frame supporting the container holder and the at least one station;
wherein the spring is arranged to the container holder for biasing the received repository in the unloaded position; and
wherein the spring is arranged for biasing the received repository upwards.

10-11. (canceled)

12. The compounding system according to claim 1,
wherein the holder coupling end comprises a first thread for coupling with a second thread of the container; and
wherein the compounding system comprises:
a rotation actuator for rotating the container for coupling to and decoupling from repository; and
a controller configured for controlling the unloading means and rotation actuator such that the unloading means are in the unloaded condition during that the repository is coupled to and/or decoupled from the container.

13. The compounding system according to claim 1, wherein an adapter is arranged to the repository for adapting the shape of the repository to cooperate with the at least one station.

14. The compounding system according to claim 13, wherein the at least one station has a shape preventing rotation of the received repository in the at least one station.

15. The compounding system according to claim 14, wherein the shape of the at least one station comprises a hole arranged for receiving the repository vertically from above.

16. The compounding system according to claim 15, wherein the hole comprises a stability notch arranged for cooperating with a stability protrusion of the received repository or the adapter for the received repository for prohibiting rotation in a horizontal plane (H), and/or guiding translation of the received repository or the adapter for the received repository in a vertical direction (V).

17. The compounding system according to claim 15,
wherein the received repository or the adapter for the received repository comprises at least two weighing protrusion; and
wherein the cradle comprises at least two contacting surfaces arranged for supporting the at least two weighing protrusions in the loaded condition.

18. The compounding system according to claim 1, wherein the at least one station comprises:
receiving notches arranged for receiving the repository or an adapter for the received repository; and
locking means arranged for sliding out of the notches when the repository or the adapter for the repository is received, and confining the received repository or the adapter for the received repository to the loaded condition or the unloaded condition.

19. The compounding system according to claim 18,
wherein the locking means comprise sliding means rotational means, and an entrance surface; and
wherein the sliding means and the entrance surface are arranged for sliding the locking means out of the notches with the applied force of the repository or the adapter for the repository on the at least one station.

20. The compounding system according to claim 19, wherein the at least one station comprises a manual control for manually controlling the sliding means.

21. The compounding system according to claim 18, wherein the locking means comprise an abutment surface arranged for abutting the received repository in the unloaded condition.

22. The compounding system according to claim 1, wherein the weighing unit comprises a load cell connected eccentric to the cradle.

23-24. (canceled)
